(19) United States
(12) Patent Application Publication
(10) Pub. No.: US 2013/0019122 A1
(43) Pub. Date: Jan. 17, 2013

(54) STORAGE DEVICE AND ALTERNATIVE STORAGE MEDIUM SELECTION METHOD

(71) Applicants: Hidejirou Daikokuya, Kawasaki (JP); Kazuhiko Ikeuchi, Kawasaki (JP); Takeshi Watanabe, Kawasaki (JP); Norihide Kubota, Kawasaki (JP); Atsushi Igashira, Yokohama (JP); Kenji Kobayashi, Kawasaki (JP); Ryota Tsukahara, Kasawaki (JP)

(72) Inventors: Hidejirou Daikokuya, Kawasaki (JP); Kazuhiko Ikeuchi, Kawasaki (JP); Takeshi Watanabe, Kawasaki (JP); Norihide Kubota, Kawasaki (JP); Atsushi Igashira, Yokohama (JP); Kenji Kobayashi, Kawasaki (JP); Ryota Tsukahara, Kasawaki (JP)

(73) Assignee: FUJITSU LIMITED, Kawasaki-shi (JP)

(21) Appl. No.: 13/527,067

(22) Filed: Jun. 19, 2012

(30) Foreign Application Priority Data
Jul. 13, 2011 (JP) 2011-155023

(51) Int. Cl. G06F 11/20

(52) U.S. Cl. 714/6.3; 714/E11.089

(57) ABSTRACT

A storage device includes: a determination unit to determine an operation of a storage group including a plurality of storage medium based on an access operation on a logical volume serving as an access target of the storage group; and a selection unit to select based on the operation of the storage group, when a failure of at least one of the plurality of storage medium is detected, an alternative storage medium from the at least one of the plurality of storage medium.

### CROSS-REFERENCE TO RELATED APPLICATION(S)

This application is based upon and claims the benefit of priority of the prior Japanese Patent Application No. 2011-155023, filed on Jul. 13, 2011, the entire contents of which are incorporated herein by reference.

### FIELD

The embodiments discussed herein are related to a storage device and the like.

### BACKGROUND

When a failure has occurred in a disk within a storage device, the disk in which the failure has occurred is substituted by an auxiliary disk called a hot spare (HS).

When the disk failure of a storage device including a multiplexed disk has been detected, an HS is selected based on a priority condition from an HS group available as an alternative to the failed disk, and the failed disk is replaced with the selected HS. For example, the priority condition may be that the type of the HS is the same as that of the failed disk.

As an alternative to the failed disk, an HS may be selected that coincides with or is closely related to the physical specification of the disk in which a failure has occurred.

Related technique is disclosed in Japanese Laid-open Patent Publication No. 2000-357061, Japanese Laid-open Patent Publication No. 2007-87039, or the like.

### SUMMARY

According to one aspect of the embodiments, a storage device includes: a determination unit to determine an operation of a storage group including a plurality of storage medium based on an access operation on a logical volume serving as an access target of the storage group; and a selection unit to select based on the operation of the storage group, when a failure of at least one of the plurality of storage medium is detected, an alternative storage medium from the at least one of the plurality of storage medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary RAID device;

FIG. 2 illustrates an exemplary volume table;

FIG. 3 illustrates an exemplary RAID group table;

FIG. 4 illustrates an exemplary disk table;

FIG. 5 illustrates an exemplary a relationship among a volume, a RAID group, and a disk;

FIG. 6 illustrates an exemplary volume operation determination process;

FIG. 7 illustrates an exemplary RAID group operation determination process;

FIG. 8 illustrates an exemplary HS selection process; and

FIG. 9 illustrates an exemplary HS selection process.

### DESCRIPTION OF EMBODIMENTS

An HS, which is to be an alternative to a disk in which a failure has occurred, may not be adequately selected.

For example, a storage device may includes disks whose numbers of revolutions are different from each other. While a disk whose number of revolutions is the same as that of the disk in which a failure has occurred may be selected as an alternative HS a disk whose number of revolutions is small may be selected depending on a situation as an alternative HS. As a result, even in a case where the storage device adopts an operation of placing priority on a response associated with a host, a response after the selected HS may be reduced compared to before the substitution.

As the storage device, a Redundant Arrays of Inexpensive Disks (RAID) device may be used. As a storage medium, a disk may be used.

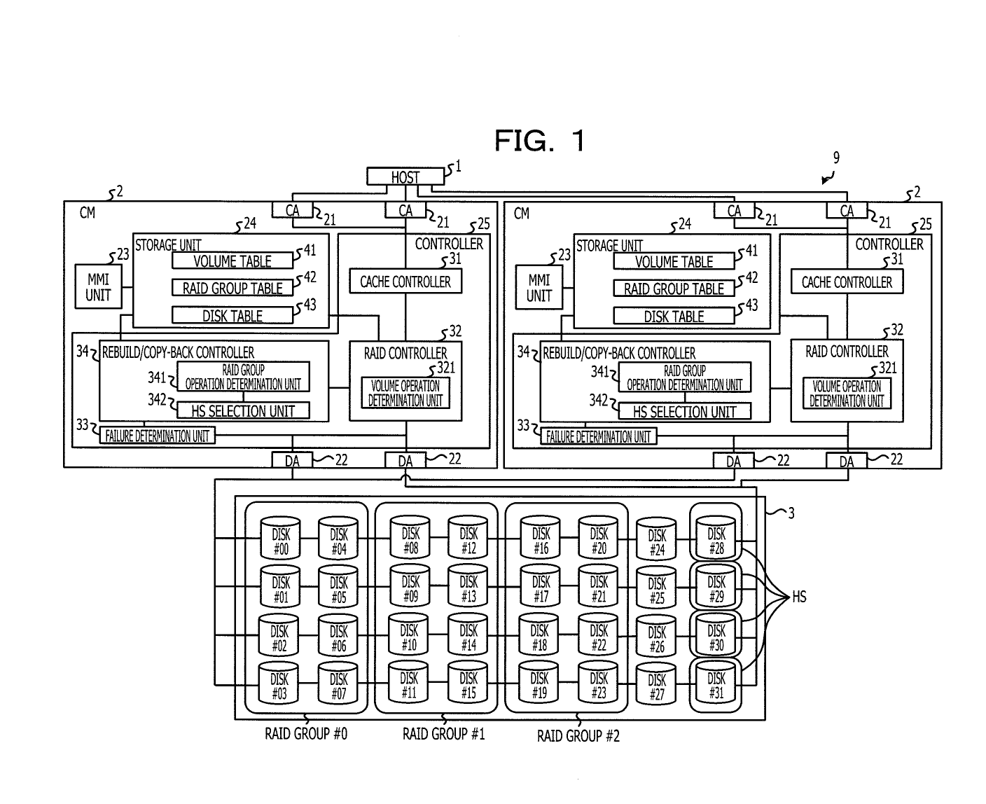

FIG. 1 illustrates an exemplary RAID device. A RAID device 9 includes a host 1, a control module (CM) 2, and a disk group 3. The host 1 is coupled to the CM 2, and notifies the CM 2 of an input/output request. The disk group 3 is coupled to the CM 2, and may include a plurality of disks functioning as a storage. The RAID device 9 may also be a small-scale RAID device including two CMs 2, and may also be a medium-scale RAID device including four CMs 2 or a large-scale RAID device including eight CMs 2.

Disks included in the RAID device 9 may be grouped as RAID groups. For example, eight disks, disks #00 to #07, may be included in a RAID group #0, and eight disks, disks #08 to #15, may be included in a RAID group #1. Eight disks, disks #16 to #23, may be included in a RAID group #2.

Four disks, disks #28 to #31, may be disposed as auxiliary disks to be alternatives to a disk in which a failure occurs. The auxiliary disk may be referred as a hot spare (HS). The HSs may include an HS (Dedicated Hot Spare) where a specific RAID group is to be a target and an HS (Global Hot Spare) where all RAID groups are to be targets. In the case of HSs where specific RAID groups are to be targets, since HSs are prepared for individual RAID groups, a cost may increase. The HS where all RAID groups are to be targets may be adopted.

In each RAID group, disks according to the operation purpose of a user may be disposed. For example, the operation purpose may include an operation purpose of placing priority on a response to the host 1 or an operation purpose of placing priority on the backup of data. In a RAID group used for the operation purpose of placing priority on a response to the host 1, a disk whose number of revolutions is larger than an average value, for example, may be disposed so as to reduce the increase of a response time. In a RAID group used for the operation purpose of placing priority on the backup of data, since a performance is not important, a disk whose number of revolutions is smaller than the average value may be disposed, for example. In FIG. 1, the RAID group #0 may have the operation purpose of placing priority on a response, and a disk whose number of revolutions is 15000 rpm (revolution per minute) may be disposed therein. The RAID group #2 may have the operation purpose of placing priority on backup, and a disk whose number of revolutions is 7200 rpm may be disposed therein. When the RAID group #1 may have the operation purpose of placing priority on a response or may have the operation purpose of placing priority on backup, a disk whose number of revolutions is 10000 rpm may be disposed therein. All individual disks included in the RAID groups may have the same number of revolutions or may not have the same number of revolutions.

The CM 2 includes a channel adapter (CA) 21, a disk-side adapter (DA) 22, a man-machine interface (MMI) unit 23, a storage unit 24, and a controller 25. The CA 21 may be a communication interface establishing communication connection with the host 1. The DA 22 may be a communication interface establishing communication connection with the disk group 3. The MMI unit 23 may be a man-machine interface coupling to an input/output device. For example, an input device in the input/output device may include a keyboard, a mouse, a tablet, or the like. For example, an output device in the input/output device may include a display, a printer, a speaker, or the like. The controller 25 controls the whole CM 2.

The storage unit 24 includes a volume table 41, a RAID group table 42, and a disk table 43. The volume table 41 stores therein management information whose unit is based on a volume and access information for the disk group 3, whose unit is based on a volume. The RAID group table 42 stores therein management information whose unit is based on a RAID group. The disk table 43 stores therein management information whose unit is based on a disk. The volume may indicate each group which are set as a logical storage and are obtained by grouping a plurality of disks or storage areas which are obtained by dividing a disk, and may be an access target when data is read or written. In each RAID group, a plurality of volumes may be created.

The controller 25 includes a cache controller 31, a RAID controller 32, a failure determination unit 33, and a rebuild/copy-back controller 34. The RAID controller 32 includes a volume operation determination unit 321. The rebuild/copy-back controller 34 includes a RAID group operation determination unit 341 and an HS selection unit 342.

The cache controller 31 controls a cache based on an access request of the host 1 for data. For example, when acquiring a read request for data from the host 1, the cache controller 31 reads the data from a corresponding volume in the disk group 3 in response to the read request, and loads the data into a cache. Reading and loading data from the volume into the cache may be referred as “staging”. The cache controller 31 notifies the volume operation determination unit 321 of the identification information of a volume in which the staging has been performed. When acquiring, from the host 1, a write request for data, the cache controller 31 writes the data into a corresponding volume in the disk group 3 in response to the write request. Writing the data from the cache into the volume may be referred as “write-back”. The cache controller 31 notifies the volume operation determination unit 321 of the identification information of a volume in which the write-back has been performed.

The volume operation determination unit 321 determines, based on an access operation on each volume, whether the volume adopts the operation purpose of placing priority on a response or the operation purpose of placing priority on backup. For example, during a certain time period from a time when a new volume has been generated in a RAID group, the volume operation determination unit 321 counts the frequencies of the staging and the write-back with respect to each volume generated in the RAID group. The volume operation determination unit 321 stores, in the volume table 41, a count result with respect to each volume. A timing when the frequency is counted may be a time when a new volume has been generated in a RAID group or a preliminarily defined time point, for example. The certain time period during which the frequency is counted may be a time period for which it is possible to execute the staging and the write-back, and may be 1 day or 10 days, for example.

After the certain time period has elapsed, the volume operation determination unit 321 compares the frequency of the staging with the frequency of the write-back with respect to each volume. When the frequency of the staging coincides with or is less than the frequency of the write-back, the operation purpose is determined as a backup priority. For example, when the operation purpose is to place priority on backup, a number of write-back operations in which data is written into a volume may be large, and a number of staging operations in which data is read from the volume may be small. Therefore, when the frequency of the staging coincides with or is less than the frequency of the write-back, the operation purpose may be determined as the backup priority.

When the frequency of the staging is larger than the frequency of the write-back, the operation purpose may be determined as the response priority. For example, when the operation purpose is to place priority on a response, the number of staging operations may be larger than the number of write-back operations. For example, when the disk group 3 is used as a database, the sequential staging operations continues, and the number of the write-back operations may be smaller than the number of the staging operations. Therefore, when the frequency of the staging is larger than the frequency of the write-back, the operation purpose may be determined as the response priority.

The volume operation determination unit 321 stores, in the operation determination result of the volume table 41, an operation purpose determined with respect to each volume.

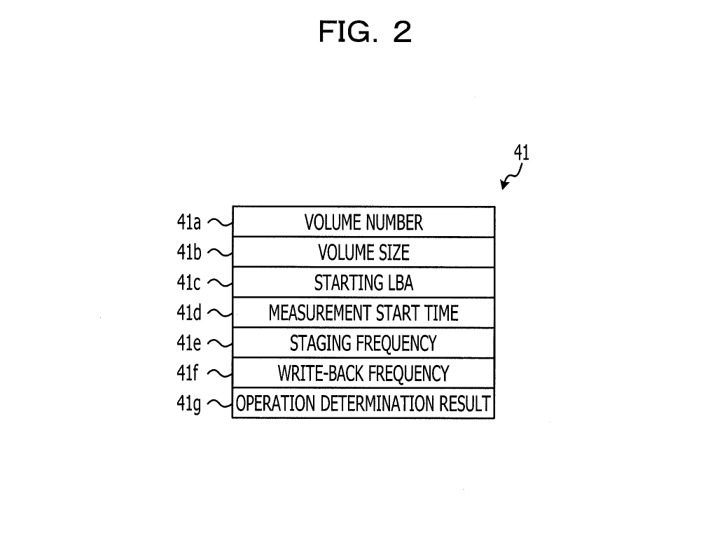

FIG. 2 illustrates an exemplary volume table. FIG. 2 may illustrate the data structure of the volume table. With respect to each volume number 41a, the volume table 41 stores therein a volume size 41b and a starting Logical Block Addressing (LBA) 41c. With respect to each volume number 41a, the volume table 41 stores therein a measurement start time 41d, a staging number 41e, a write-back frequency 41f, and an operation determination result 41g.

A number identifying a volume is stored in the volume number 41a. The size of the volume is stored in the volume size 41b. In the starting LBA 41c, an LBA from which the volume indicated by the volume number 41a is started is stored. The LBA indicates an address assigned to an access unit (sector) for a disk serving as a physical medium, and, for example, a numeric character may be assigned to the LBA in order beginning with “0”.

The starting time of the measurement of an access operation is stored in the measurement start time 41d. In the staging number 41e, the frequency of staging is stored, the staging being performed on the volume indicated by the volume number 41a after the start of the measurement of the access operation. In the write-back frequency 41f, the frequency of write-back is stored, the write-back being performed on the volume indicated by the volume number 41a after the start of the measurement of the access operation. In the operation determination result 41g, a determination result is stored that indicates whether the operation purpose of placing priority on a response or the operation purpose of placing priority on backup is adopted with respect to the volume indicated by the volume number 41a. For example, “1” indicating the operation purpose of placing priority on a response, “2” indicating the operation purpose of placing priority on backup, or “0” indicating that the operation purpose has not been decided may be stored in the operation determination result 41g. Even during the measurement of the access operation, a result determined based on the previous measurement may be held in the operation determination result 41g.

When detecting the failure of a disk in the RAID group, the failure determination unit 33 illustrated in FIG. 1 determines whether or not the disk having the failure is to be separated. For example, based on statistical information relating to a failure, which is calculated in the event of the failure, the failure determination unit 33 determines whether or not the disk having the failure is to be separated. When it is determined that the disk having the failure to be separated, the failure determination unit 33 notifies the RAID group operation determination unit 341 of the disk to be separated. When it is determined that the disk having the failure is not to be separated, the failure determination unit 33 calculates, from the detected failure, the statistical information relating to a failure, and updates the statistical information. The failure determination unit 33 continues the operation of the disk having the failure.

Based on the access operation on a volume within the RAID group, the RAID group operation determination unit 341 determines whether the RAID group including the failed disk adopts the operation purpose of placing priority on a response or the operation purpose of placing priority on backup. For example, when acquiring a notice of the disk to be separated from the failure determination unit 33, the RAID group operation determination unit 341 searches the RAID group to which the disk to be separated belongs based on the RAID group table 42. The RAID group operation determination unit 341 determines whether or not every volume belonging to the searched RAID group adopts the operation purpose of placing priority on backup.

When it is determined that every volume adopts the operation purpose of placing priority on backup, the RAID group operation determination unit 341 determines that the searched RAID group adopts the operation purpose of placing priority on backup. When it is determined that at least one volume adopts the operation purpose of placing priority on a response, the RAID group operation determination unit 341 determines that the searched RAID group adopts the operation purpose of placing priority on a response. For example, when at least one volume, which adopts the operation purpose of placing priority on a response, exists in the searched RAID group, the operation purpose of placing priority on a response may be set in the RAID group so as to reduce the delay of a response in the whole RAID group. The RAID group operation determination unit 341 notifies the HS selection unit 342 of the operation purpose of the searched RAID group.

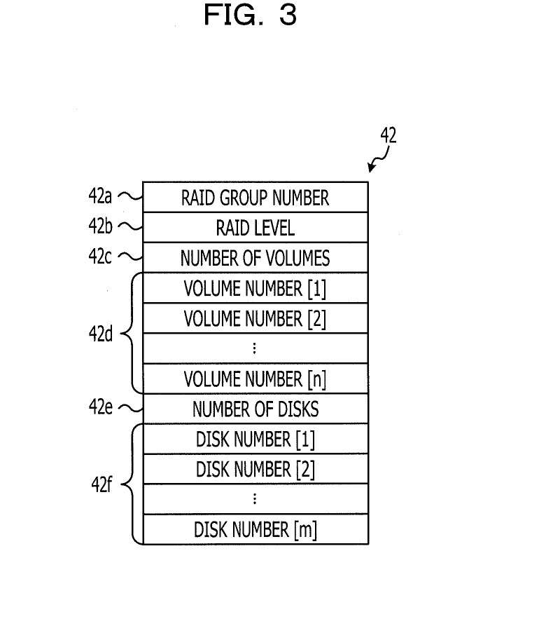

FIG. 3 illustrates an exemplary RAID group table. FIG. 3 may illustrate the data structure of the RAID group table. With respect to each RAID group number 42a, the RAID group table 42 stores therein a RAID level 42b and the number of volumes 42c with associating each other. With respect to each RAID group number 42a, the RAID group table 42 stores therein volume numbers [1] to [n] 42d, the number of disks 42e, and disk numbers [1] to [m] 42f with associating each other. The “n” and “m” indicate natural numbers greater than or equal to “2”, and may be fixed numbers or variable numbers. The “n” may be a number including the number of volumes, and the “m” may be a number including the number of disks.

In the RAID group number 42a, a number that identifies the RAID group is stored. The RAID level of a RAID group indicated by the RAID group number 42a is stored in the RAID level 42b. The number of volumes belonging to the RAID group is stored in the number of volumes 42c. The identification numbers of volumes corresponding to the number of volumes belonging to the RAID group are stored in the volume numbers 42d. The number of disks belonging to the RAID group is stored in the number of disks 42e. The identification numbers of disks corresponding to the number of disks belonging to the RAID group are stored in the disk numbers 42f. The RAID group operation determination unit 341 may refer to the disk number 42f, and hence the RAID group to which the disk to be separated belongs may be searched.

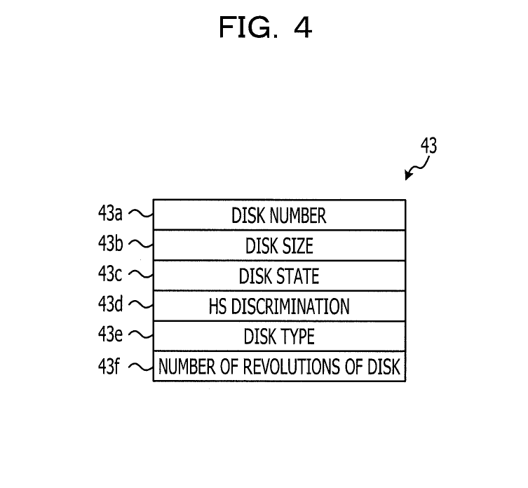

FIG. 4 illustrates an exemplary disk table. FIG. 4 may illustrate the data structure of the disk table. With respect to each disk number 43a, the disk table 43 stores therein a disk size 43b, a disk state 43c, an HS discrimination 43d, a disk type 43e, and the number of revolutions of a disk 43f with associating each other. A number identifying a disk is stored in the disk number 43a. The size of a disk indicated by the disk number 43a is stored in the disk size 43b. The state of the disk indicated by the disk number 43a is stored in the disk state 43c. The discrimination of whether or not the disk indicated by the disk number 43a is an HS is stored in the HS discrimination 43d. In the disk type 43e, the type of the disk indicated by the disk number 43a, for example, the type of a disk such as a Hard Disk Drive (HDD), a Solid State Drive (SSD), or the like, is stored. The number of revolutions of a disk is stored in the number of revolutions of a disk 43f.

The HS selection unit 342 illustrated in FIG. 1 selects the HS of the corresponding failed disk based on the operation purpose of a RAID group to which a failed disk belongs.

For example, when the RAID group has the operation purpose of placing priority on a response, the HS selection unit 342 obtains the number of revolutions of a disk whose number of revolutions is the smallest in the RAID group based on the number of revolutions of a disk 43f in the disk table 43. The number of revolutions of a disk whose number of revolutions is the smallest in the RAID group may be referred as “the basic number of revolutions”. The HS selection unit 342 determines whether or not, from among HSs, there is an HS having the same number of revolutions as the basic number of revolutions. When there is an HS having the same number of revolutions as the basic number of revolutions, the HS selection unit 342 selects the HS having the same number of revolutions. When there is no HS having the same number of revolutions as the basic number of revolutions, the HS selection unit 342 selects an HS having the number of revolutions that is greater than the basic number of revolutions and nearest to the basic number of revolutions. In a case where there is no HS having the number of revolutions greater than the basic number of revolutions, when there is an HS of SSD, the HS selection unit 342 selects the HS of SSD. Owing to the SSD capable of reading and writing at a fast rate, the operation of placing priority on a response may be maintained. In order to maintain the operation of placing priority on a response, the HS selection unit 342 may not select an HS having the number of revolutions smaller than the basic number of revolutions.

For example, when the RAID group has the operation purpose of placing priority on backup, the HS selection unit 342 obtains the basic number of revolutions of the RAID group based on the number of revolutions of a disk 43f in the disk table 43. The HS selection unit 342 determines whether or not, from among HSs, there is an HS having the same number of revolutions as the basic number of revolutions. When there is an HS having the same number of revolutions as the basic number of revolutions, the HS selection unit 342 selects the HS having the same number of revolutions. When there is no HS having the same number of revolutions as the basic number of revolutions, the HS selection unit 342 selects an HS having the number of revolutions that is smaller than the basic number of revolutions and nearest to the basic number of revolutions. In order to leave an HS used for the operation of placing priority on a response, the HS selection unit 342 may not select an HS having the number of revolutions greater than the basic number of revolutions and an SSD.

When an HS is selected, the HS selection unit 342 restructures (rebuilds) the data of the failed disk in the selected HS. The HS selection unit 342 separates the failed disk. The HS selection unit 342 causes the data of the HS to be restored (copied back) in a normally functioning disk.

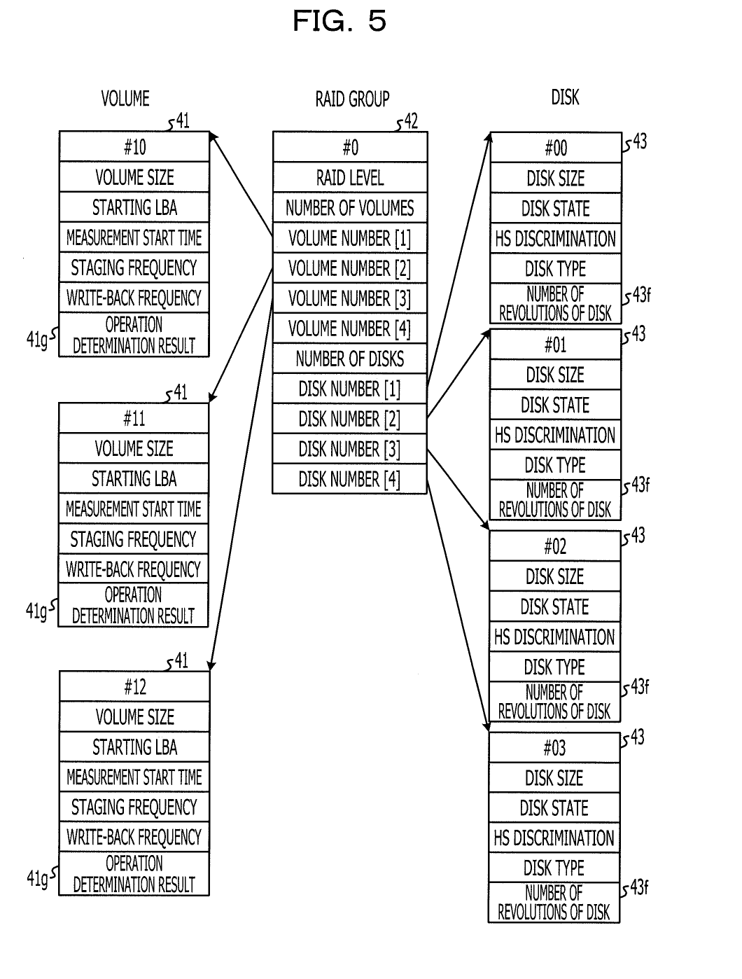

FIG. 5 illustrates an exemplary relationship among a volume, an exemplary RAID group, and an exemplary disk. The RAID group includes a plurality of volumes and a plurality of disks independently of the volumes. The RAID group of a RAID group number #0 includes volumes of volume numbers #10, #11, and #12. The RAID group of a RAID group number #0 includes disks of disk numbers #00, #01, #02, and #03.

A RAID group including the failed disk may correspond to the RAID group number #0. Based on the operation determination result 41g in the volume table 41, the RAID group operation determination unit 341 determines whether or not all of the volumes #10 to #12 belonging to the RAID group of #0 have the operation purpose of placing priority on backup. Based on the operation purpose determined by the RAID group operation determination unit 341, the HS selection unit 342 selects an HS for the failed disk. The HS selection unit 342 obtains the basic number of revolutions of the RAID group of #0 based on the number of revolutions of a disk 43f in the disk table 43. For example, the HS selection unit 342 obtains the basic number of revolutions of the RAID group of #0 based on the numbers of revolutions of the disks #00 to #03. Using the obtained basic number of revolutions, the HS selection unit 342 may select an HS according to the operation purpose.

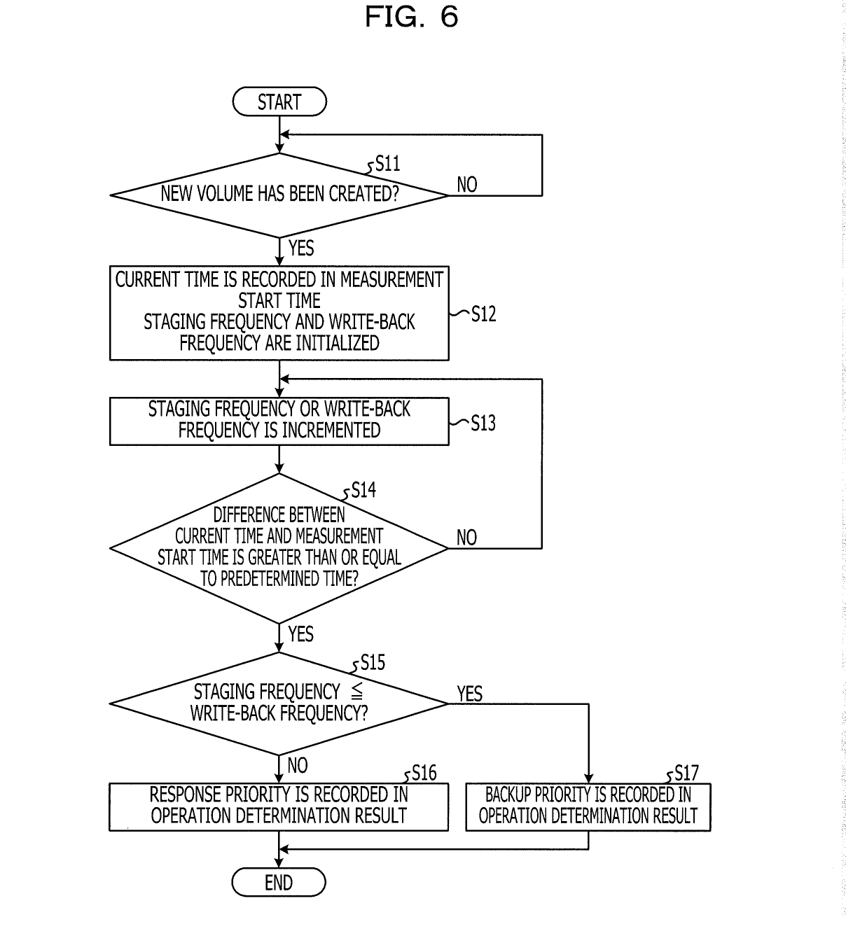

FIG. 6 illustrates an exemplary volume operation determination process.

The volume operation determination unit 321 determines whether or not a new volume has been created in one of the RAID groups existing in the RAID device 9 (an Operation S11). When no new volume has been created (the Operation S11: No), the volume operation determination unit 321 repeats the determination processing until a new volume is created.

When a new volume has been created (the Operation S11: Yes), the volume operation determination unit 321 records a current time in the measurement start time 41d in the volume table 41 with respect to every volume existing in the RAID device 9. With respect to every volume existing in the RAID device 9, the volume operation determination unit 321 initializes, to “0”, the staging number 41e and the write-back frequency 41f in the volume table 41 (an Operation S12).

With respect to a volume subjected to staging, the volume operation determination unit 321 increments the staging number 41e in the volume table 41. With respect to a volume subjected to write-back, the volume operation determination unit 321 increments the write-back frequency 41f in the volume table 41 (an Operation S13).

The volume operation determination unit 321 determines whether or not a difference between the current time and the measurement start time 41d recorded in the volume table 41 is greater than or equal to a predetermined time (an Operation S14). When the difference is not greater than or equal to the predetermined time (the Operation S14: No), the process shifts to the Operation S13 so as to continue the measurement of the access operation.

When the difference is greater than or equal to the predetermined time (the Operation S14: Yes), the volume operation determination unit 321 determines whether or not a staging number is less than or equal to a write-back number, with respect to every volume existing in the RAID device 9 (an Operation S15).

With respect to a volume where the staging number is larger than the write-back frequency (the Operation S15: No), the volume operation determination unit 321 determines that the volume adopts response priority, and records the determination result in the operation determination result 41g in the volume table 41 (an Operation S16). With respect to a volume where the staging number is less than or equal to the write-back number (the Operation S15: Yes), the volume operation determination unit 321 determines that the volume adopts backup priority, and records the determination result in the operation determination result 41g in the volume table 41 (an Operation S17). After the volume operation determination unit 321 has recorded the determination result with respect to every volume existing in the RAID device 9, the volume operation determination process is terminated.

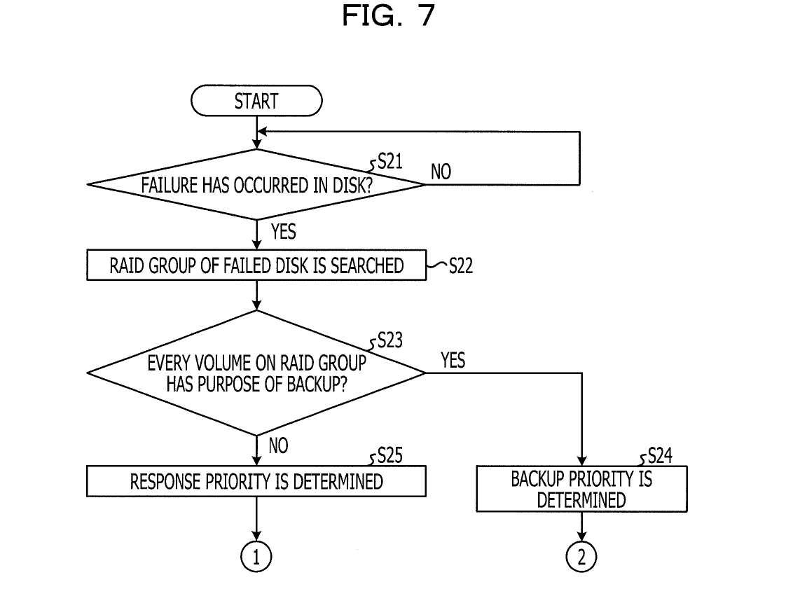

FIG. 7 illustrates an exemplary RAID group operation determination process.

The failure determination unit 33 determines whether or not a failure has occurred in a disk (an Operation S21). When no failure has occurred in a disk (the Operation S21: No), the failure determination unit 33 repeats the determination process until a failure occurs in a disk. When a failure has occurred in a disk (the Operation S21: Yes), the RAID group operation determination unit 341 searches the RAID group of the failed disk based on the RAID group table 42 (an Operation S22).

The RAID group operation determination unit 341 determines whether or not every volume belonging to the searched RAID group has the operation purpose of placing priority on backup (an Operation S23). For example, based on the operation determination result 41g in the volume table 41, the RAID group operation determination unit 341 determines whether or not every volume belonging to the searched RAID group has the operation purpose of placing priority on backup. In the operation determination result 41g, the determination result is stored that indicates the operation purpose of placing priority on a response or the operation purpose of placing priority on backup. When every volume has the operation purpose of placing priority on backup (the Operation S23: Yes), the RAID group operation determination unit 341 determines that the searched RAID group has the operation purpose of placing priority on backup (an Operation S24). The HS selection unit 342 executes HS selection processing in the RAID group having the purpose of backup.

When at least one volume has the operation purpose of placing priority on a response (the Operation S23: No), the RAID group operation determination unit 341 determines that the searched RAID group has the operation purpose of placing priority on a response (an Operation S25). The HS selection unit 342 executes the HS selection process in the RAID group placing priority on a response.

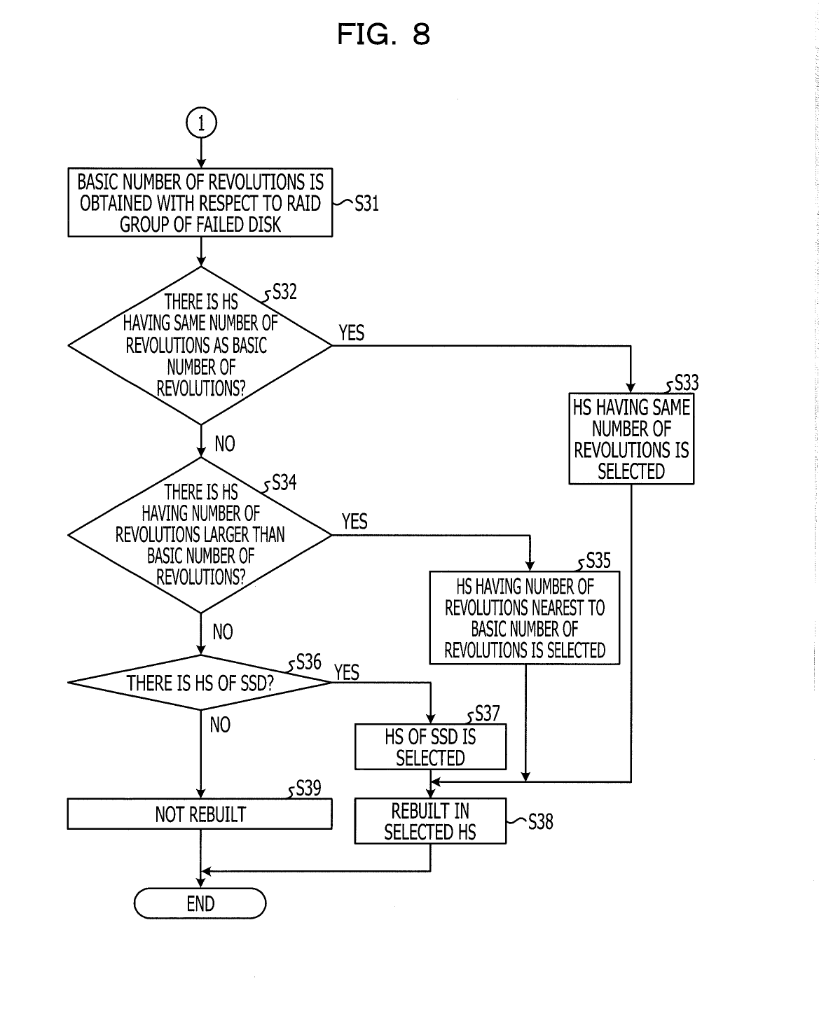

FIG. 8 illustrates an exemplary HS selection process. The process in FIG. 8 may be the HS selection process performed in the RAID group placing priority on a response.

The HS selection unit 342 obtains the basic number of revolutions in the RAID group of the failed disk (an Operation S31). For example, the HS selection unit 342 reads the number of revolutions of a disk of a disk belonging to the RAID group of the failed disk from the disk table 43, and obtains the basic number of revolutions based on the read number of revolutions.

The HS selection unit 342 determines whether or not there is an HS having the same number of revolutions as the obtained basic number of revolutions (an Operation S32). When there is an HS having the same number of revolutions as the basic number of revolutions (the Operation S32: Yes), the HS selection unit 342 selects the HS having the same number of revolutions as the basic number of revolutions (an Operation S33). The process proceeds to an Operation S38.

When there is no HS having the same number of revolutions as the basic number of revolutions (the Operation S32: No), the HS selection unit 342 determines whether or not there is an HS having the number of revolutions larger than the basic number of revolutions (an Operation S34). When there is an HS having the number of revolutions larger than the basic number of revolutions (the Operation S34: Yes), the HS selection unit 342 selects an HS having the number of revolutions nearest to the basic number of revolutions from among HSs having the numbers of revolutions larger than the basic number of revolutions (an Operation S35). The process proceeds to the Operation S38.

On the other hand, when there is no HS having the number of revolutions larger than the basic number of revolutions (an Operation S34: No), the HS selection unit 342 determines whether or not there is an HS of SSD (an Operation S36). When there is an HS of SSD (the Operation S36: Yes), the HS selection unit 342 selects the HS of SSD (an Operation S37). The process proceeds to the Operation S38.

In the Operation S38, when the HS selection unit 342 has selected an HS, the data of the failed disk is rebuilt in the selected HS (the Operation S38). When there is no HS of SSD (the Operation S36: No), the HS selection unit 342 does not rebuild the data of the failed disk (an Operation S39).

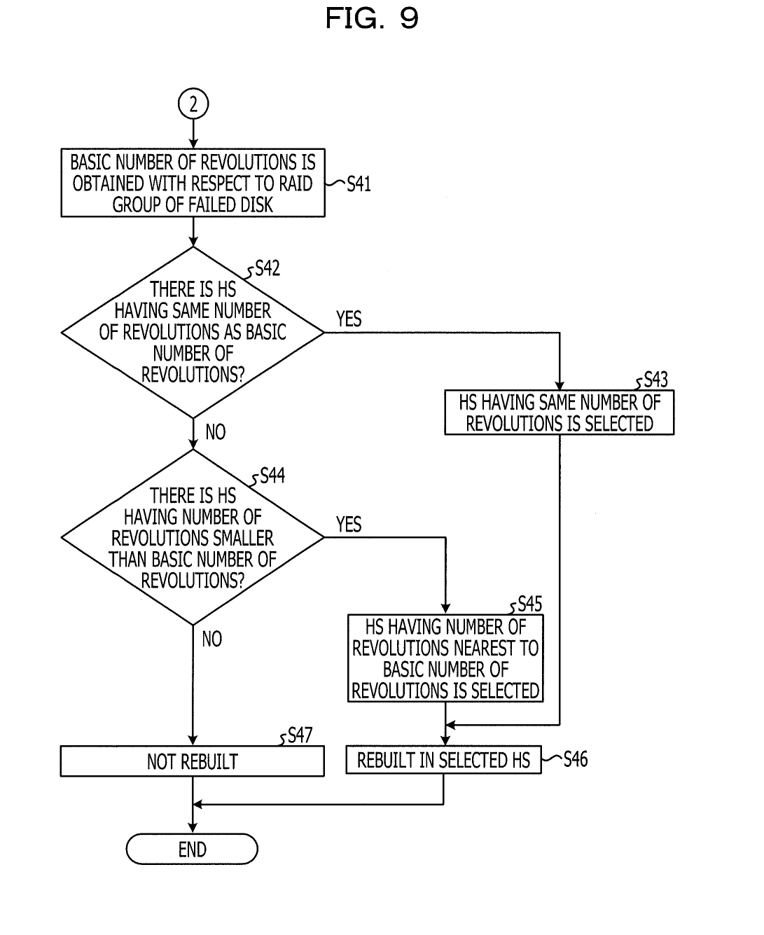

FIG. 9 illustrates an exemplary HS selection process. The process illustrated in FIG. 9 may be the HS selection process performed in the RAID group placing priority on backup.

With respect to the RAID group of the failed disk, the HS selection unit 342 obtains the basic number of revolutions (an Operation S41). For example, the HS selection unit 342 reads the number of revolutions of a disk of a disk belonging to the RAID group of the failed disk from the disk table 43, and obtains the basic number of revolutions based on the read number of revolutions.

The HS selection unit 342 determines whether or not there is an HS having the same number of revolutions as the obtained basic number of revolutions (an Operation S42). When there is an HS having the same number of revolutions as the basic number of revolutions (the Operation S42: Yes), the HS selection unit 342 selects the HS having the same number of revolutions as the basic number of revolutions (an Operation S43). The process proceeds to an Operation S46.

When there is no HS having the same number of revolutions as the basic number of revolutions (an Operation S42: No), the HS selection unit 342 determines whether or not there is an HS having the number of revolutions smaller than the basic number of revolutions (an Operation S44). When there is an HS having the number of revolutions smaller than the basic number of revolutions (the Operation S44: Yes), the HS selection unit 342 selects an HS having the number of revolutions nearest to the basic number of revolutions from among HSs having the numbers of revolutions smaller than the basic number of revolutions (an Operation S45). The process proceeds to the Operation S46.

In the Operation S46, when the HS selection unit 342 selects an HS, the data of the failed disk is rebuilt in the selected HS (the Operation S46). When there is no HS having the number of revolutions smaller than the basic number of revolutions (the Operation S44: No), the HS selection unit 342 does not rebuild the data of the failed disk (an Operation S47).

When the RAID group including the failed disk does not have the operation purpose of placing priority on backup, the HS selection unit 342 may not select, as an HS, an alternative disk having the number of revolutions larger than the basic number of revolutions and an SSD. The HS selection unit 342 may select, as an HS, an alternative disk having the number of revolutions larger than the basic number of revolutions and an SSD.

With respect to each volume, the volume operation determination unit 321 compares the number of staging with the number of write-back. When the number of staging is equal to or smaller than the number of write-back, the volume operation determination unit 321 determines the operation purpose of placing priority on backup. For example, the RAID device 9 may include an advanced copy function for copying using a storage without using the controller 25 in the CM 2. The volume operation determination unit 321 may determine that the volume of a copy destination has the operation purpose of placing priority on backup. The volume operation determination unit 321 may determine that the volume of a copy source has the operation purpose of placing priority on a response.

In response to the operation purpose of each volume belonging to the RAID group, the RAID group operation determination unit 341 determines whether the RAID group including the failed disk has the operation purpose of placing priority on a response or the operation purpose of placing priority on backup. For example, based on the RAID level of the RAID group, the RAID group operation determination unit 341 may determine the operation purpose. The RAID group operation determination unit 341 may perform determination based on RAID1 or RAID1+0, which indicates mirroring, or RAID5, RAID5+0, RAID6, or RAID6+0, which indicates parity. When the RAID group corresponds to the RAID level indicating the mirroring, since there is no write penalty where data and parity before writing are read and updated parity is written at the time of writing data, the operation of response priority may be set. When the RAID group corresponds to the RAID level indicating the parity, since a data retention amount for the number of disks is large, the operation of backup priority may be set. When the RAID level of the RAID group indicates the parity, the RAID group operation determination unit 341 may determine the operation purpose of placing priority on backup. When the RAID level of the RAID group indicates the mirroring, the RAID group operation determination unit 341 may determine the operation purpose of placing priority on a response.

Based on the access operation on a logical volume serving as the access target of the RAID group, the RAID device 9 determines whether the RAID group including a plurality of disks has the operation of placing priority on a response or the operation of placing priority on backup. When the disk failure of the RAID group is detected, the RAID device 9 selects the alternative disk of a disk from which a failure has been detected based on the determined operation of the RAID group.

The RAID device 9 counts the number of times data is read from a logical volume and data is written into the logical volume, which corresponds to a predetermined time period. When the number of reading is larger than the number of writing, the RAID device 9 determines the operation of placing priority on a response. The operation of a RAID group corresponding to the logical volume may be easily determined.

When the transfer of data from the logical volume of a transfer source to the logical volume of a transfer destination is performed, the RAID device 9 determines that the logical volume of a transfer source adopts the operation of placing priority on a response. The operation of a RAID group corresponding to the logical volume may be easily determined.

When the operation of the RAID group is the operation of placing priority on a response, the RAID device 9 selects an alternative disk having the same number of revolutions as the minimum number of revolutions (the basic number of revolutions) in the RAID group to which the disk having a failure belongs. When there is no alternative disk having the same number of revolutions as the basic number of revolutions, the RAID device 9 selects an alternative disk having the number of revolutions that is larger than the basic number of revolutions and nearest to the basic number of revolutions. The operation of placing priority on a response may be maintained.

When the operation of the RAID group has the operation purpose of placing priority on backup, the RAID device 9 selects an alternative disk having the same number of revolutions as the minimum number of revolutions (the basic number of revolutions) in the RAID group to which the disk having a failure belongs. When there is no alternative disk having the same number of revolutions as the basic number of revolutions, the RAID device 9 selects an alternative disk having the number of revolutions that is smaller than the basic number of revolutions and nearest to the basic number of revolutions. The operation of placing priority on backup may be maintained. The RAID device 9 may secure, as a spare for the RAID group performing the operation of placing priority on a response, an alternative disk having the number of revolutions that is larger than the basic number of revolutions.

All or part of the RAID device 9 may be functionally or physically integrated or distributed in arbitrary units according to various loads and various statuses of use. For example, the RAID group operation determination unit 341 and the HS selection unit 342 may be integrated into one unit. The HS selection unit 342 may be distributed into a first HS selection unit for the operation purpose of placing priority on a response and a second HS selection unit for the operation purpose of placing priority on backup. The storage unit 24 may be coupled, as the external device of the CM 2, through a network.

All or arbitrary part of the CM 2 may correspond to hardware such as a CPU, an MPU, a Micro Controller Unit (MCU), a wired logic, or the like. All or arbitrary part of the controller 25 may correspond to the process of a program executed by the CPU, the MPU, the MCU, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a determination unit to determine an operation of a storage group including a plurality of storage medium based on an access operation on a logical volume serving as an access target of the storage group; and
a selection unit to select based on the operation of the storage group, when a failure of at least one of the plurality of storage medium is detected, an alternative storage medium from the at least one of the plurality of storage medium.

2. The storage device according to claim 1, wherein
the determination unit counts a reading number of data from the logical volume and a writing number of data into the logical volume during a time period, and determines the operation of the storage group based on the reading number and the writing number.

3. The storage device according to claim 2, wherein
the determination unit determines a first operation when the reading number is larger than the writing number.

4. The storage device according to claim 3, wherein
the first operation is an operation of placing priority on a response.

5. The storage device according to claim 1, wherein
the determination unit determines the operation of the storage group based on data transfer from a logical volume in one storage group a logical volume in the other storage group.

6. The storage device according to claim 5, wherein
the determination unit determines the one storage group as a first operation.

7. The storage device according to claim 6, wherein
the first operation is an operation of placing priority on a response.

8. The storage device according to claim 1, wherein the storage medium includes a disk.

9. The storage device according to claim 8, wherein
the selection unit selects the alternative storage medium based on a rotation speed of the disk in the storage group including the at least one of the plurality of storage medium.

10. The storage device according to claim 9, wherein
the selection unit selects the alternative storage medium having the rotation speed greater than or equal to a minimum rotation speed of a disk in the storage group including the at least one of the plurality of storage medium when the determination unit determines the operation of the storage group as a first operation.

11. The storage device according to claim 9, wherein
the selection unit selects the alternative storage medium having the rotation speed less than or equal to a minimum rotation speed of a disk in the storage group the at least one of the plurality of storage medium when the determination unit determines the operation of the storage group as a second operation.

12. The storage device according to claim 11, wherein
the second operation is an operation of placing priority on backup.

13. An alternative storage medium selection method comprising:
determining an operation of a storage group including a plurality of storage medium based on an access operation on a logical volume serving as an access target of the storage group; and
selecting based on the operation of the storage group, when a failure of at least one of the plurality of storage medium is detected, an alternative storage medium from the at least one of the plurality of storage medium.

14. The alternative storage medium selection method according to claim 13, further comprising:
counting a reading number of data from the logical volume and a writing number of data into the logical volume during a time period; and
determining the operation of the storage group based on the reading number and the writing number.

15. The alternative storage medium selection method according to claim 13, further comprising,
determining the operation of the storage group based on data transfer from a logical volume in one storage group a logical volume in the other storage group.

16. The alternative storage medium selection method according to claim 13, further comprising,
selecting the alternative storage medium based on a rotation speed of a disk in the storage group including the at least one of the plurality of storage medium.
